(19) United States
(12) Patent Application Publication
(10) Pub. No.: US 2010/0229987 A1
(43) Pub. Date: Sep. 16, 2010

(54) MICRO FLUIDIC DEVICE AND FLUID CONTROL METHOD

(75) Inventors: Mutsuya TAKAHASHI, Kanagawa (JP); Masaki HIROTA, Kanagawa (JP); Takayuki YAMADA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/575,136

(22) Filed: Oct. 7, 2009

(30) Foreign Application Priority Data
Mar. 16, 2009 (JP) 2009-063109

(51) Int. Cl. B01F 5/00

(52) U.S. Cl. 137/896

(57) ABSTRACT

A micro fluidic device is provided, the micro fluidic device including: at least one first introduction pipe into which first fluid is introduced; at least one second introduction pipe into which second fluid is introduced, the second introduction pipe being disposed adjacent to the first introduction pipe; a common channel connected to the first introduction pipe and the second introduction pipe, wherein in the common channel the first fluid and the second fluid are mixed; and a first group of rectification parts, the rectification parts of the first group being provided individually for the first introduction pipe or the second introduction pipe and generating a helical flow in the first fluid and the second fluid, wherein the helical flow in the first fluid and the helical flow in the second fluid have a same circumferential direction.

### CROSS-REFERENCE TO RELATED APPLICATIONS

This application is based on and claims priority under 35 U.S.C. 119 from Japanese Patent Application No. 2009-063109 filed Mar. 16, 2009.

### BACKGROUND

1. Technical Field

The present invention relates to a micro fluidic device and a fluid control method.

2. Related Art

There have hitherto been known micro fluidic devices for allowing plural fluids to pass as a laminar flow through a micro channel having a diameter of, for example, not more than 0.5 mm, mixing those fluids by means of molecular diffusion and subjecting the mixture to a compound reaction.

### SUMMARY

According to an aspect of the present invention, there is provided a micro fluidic device including:

at least one first introduction pipe into which first fluid is introduced;

at least one second introduction pipe into which second fluid is introduced, the second introduction pipe being disposed adjacent to the first introduction pipe;

a common channel connected to the first introduction pipe and the second introduction pipe, wherein in the common channel the first fluid and the second fluid are mixed; and

a first group of rectification parts, the rectification parts of the first group being provided individually for the first introduction pipe or the second introduction pipe and generating a helical flow in the first fluid and the second fluid,

wherein the helical flow in the first fluid and the helical flow in the second fluid have a same circumferential direction.

### BRIEF DESCRIPTION OF THE DRAWINGS

Exemplary embodiments of the present invention will be described in detail based on the following figures, wherein:

FIG. 1 is a perspective view showing an example of the whole configuration of a micro fluidic device according to a first exemplary embodiment of the invention;

FIG. 2 is a sectional view along an A-A line in FIG. 1;

FIG. 3 is a side view showing the whole of a rectification unit in a fluid branch part seen from a common channel side of FIG. 2;

FIGS. 4A and 4B each shows one rectification part in FIG. 3, in which FIG. 4A is a front view, and FIG. 4B is a sectional view along a B-B line in FIG. 4A;

FIG. 5 is a plan view showing a configuration of a donor substrate which is used for the manufacture of a micro fluidic device according to a first exemplary embodiment of the invention;

FIGS. 6A to 6F are each a view showing manufacturing steps of a micro fluidic device according to a first exemplary embodiment of the invention;

FIGS. 7A to 7C are each a view showing flows of a first fluid and a second fluid in a liquid branch part of a micro fluid device according to a first exemplary embodiment of the invention;

FIG. 8 is a sectional view showing a micro fluidic device according to a second exemplary embodiment of the invention;

FIG. 9 is a sectional view along a C-C line in FIG. 8 as seen form a common channel (outlet) side of FIG. 8;

FIG. 10 is a view showing rectification units disposed along a common channel;

FIG. 11 is a view showing a part of the rectification units 30A and 30B of FIG. 10 toward x-direction of FIG. 10;

FIG. 12 is a sectional view along a D-D line in FIG. 8 as seen form a common channel (outlet) side of FIG. 8;

FIG. 13 is a view showing a positional relationship between rectification parts of the rectification unit 30A and rectification parts of the rectification unit 30B shown in FIG. 10; and

FIG. 14 is an example of side view showing a micro fluidic device according to a third exemplary embodiment of the invention.

### DETAILED DESCRIPTION

### First Exemplary Embodiment

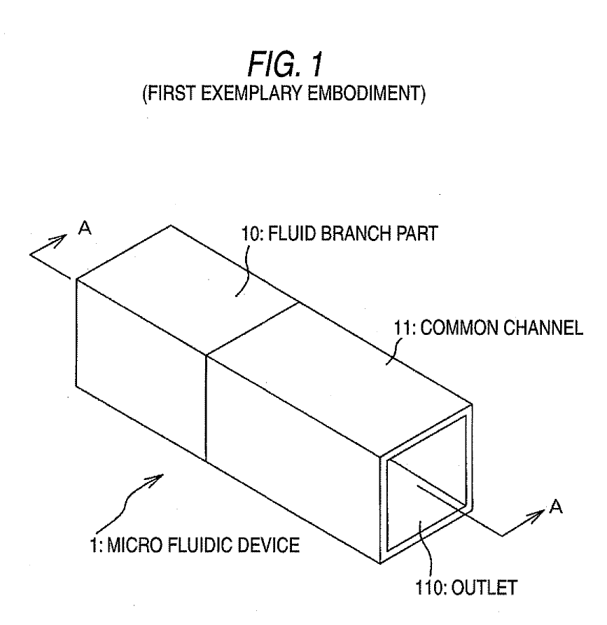

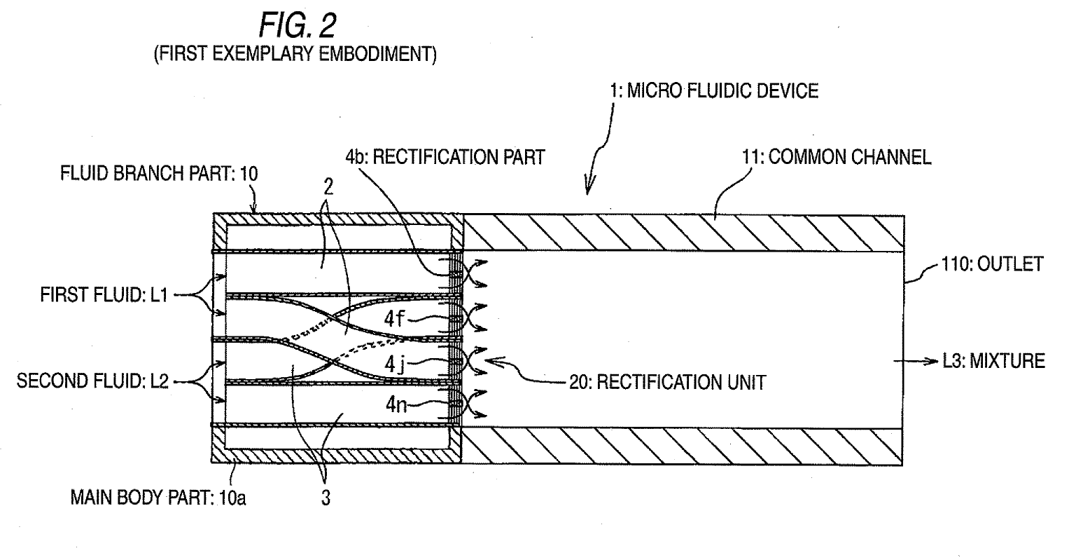

FIG. 1 is a perspective view showing an example of the whole configuration of a micro fluidic device according to a first exemplary embodiment of the invention; and FIG. 2 is a sectional view along an A-A line in FIG. 1.

This micro fluid device 1 is configured to include a fluid branch part 10 for generating a helical flow in each of introduced first fluid L1 and second fluid L2 and discharging them; and a common channel 11 for allowing the first fluid L1 and the second fluid L2 discharged from the fluid branch part 10 to pass therethrough. The first fluid L1 and the second fluid L2 are each, for example, a liquid, a powder, a gas or the like.

The micro fluid device 1 is one kind of a micro fluid apparatus for carrying out a chemical reaction between the first fluid L1 and the second fluid L2 within the common channel 11. This micro fluid apparatus includes, for example, a micro mixer or a micro reactor for merely mixing the first fluid L1 and the second fluid L2 within the common channel 11 or regulating the particle size of a powder, etc., or the like.

The common channel 11 is made of a metal (for example, Al, Ni, Cu, etc.) or a non-metal (for example, ceramics, silicon, dielectrics, etc.). The common channel 11 has a function to mix the first fluid L1 and the second fluid L2 having been discharged from a rectification unit 20 as shown in FIG. 2 and discharge the thus obtained mixture L3 from an outlet 110.

### (Configuration of Rectification Part)

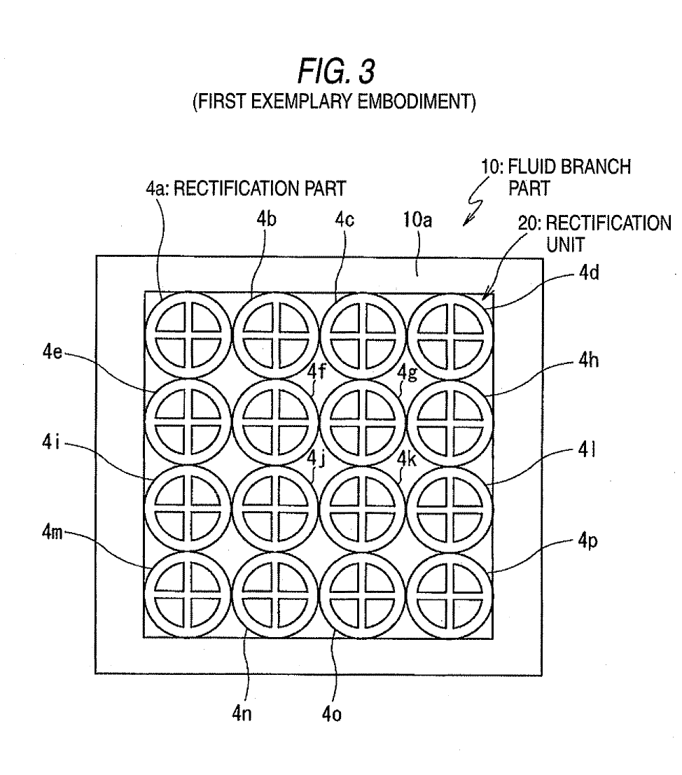

FIG. 3 is a side view showing the whole of the rectification unit seen from a common channel side of FIG. 2. The rectification unit 20 is composed of rectification parts 4a to 4p (hereinafter also referred to as “rectification part 4”) having the same configuration, which generate a helical flow in the first fluid L1 and the second fluid L2 for every first introduction pipe 2 and second introduction pipe 3, and these are arranged at regular intervals on the same plane in a manner of 4 lines and 4 rows. The first introduction pipe 2 is connected to each of the rectification parts 4a, 4c, 4f, 4h, 4i, 4k, 4n and 4p; and the second introduction pipe 3 is connected to each of the rectification parts 4b, 4d, 4e, 4g, 4j, 4l, 4m and 4o. The rectification parts 4a to 4p are not limited to this number, but the number may be arbitrarily chosen depending upon an application or the like.

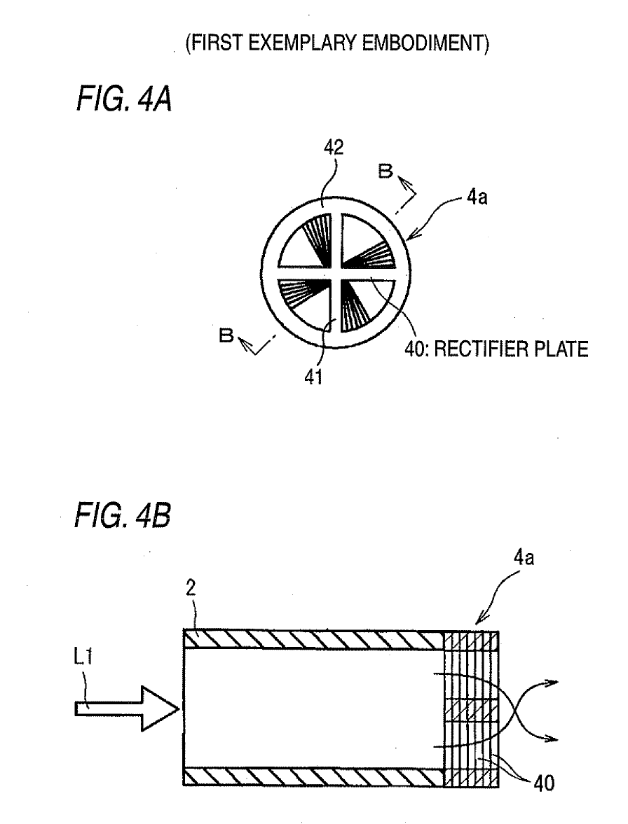

FIGS. 4A and 4B each shows one rectification part in FIG. 3, in which FIG. 4A is a front view, and FIG. 43 is a sectional view along a B-B line in FIG. 4A. As described previously, the rectification parts 4a to 4p have the same configuration. Then, the configuration of the rectification part 4a is herein described with reference to FIGS. 4A and 4B. The rectification part 4a is composed of a laminate of plural rectifier plates 40 each having a cross-shaped part 41 and a ring part 42 and provided in an outlet part of the first introduction pipe 2.

(Configuration of Donor Substrate which is Used for the Manufacture of Micro Fluidic Device)

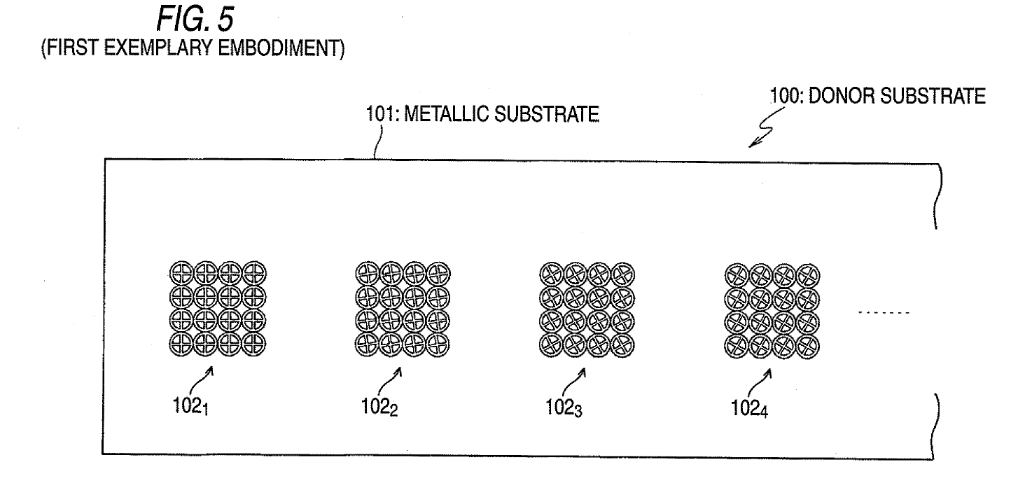

FIG. 5 is a plan view showing a configuration of a donor substrate 100 which is used for the manufacture of a micro fluidic device. The rectification unit 20 is manufactured as follows. First all, a metallic substrate 101 made of a metal such as stainless steel is prepared, and a thick photoresist is coated on the metallic substrate 101. Subsequently, the coated surface of the thick photoresist is exposed through a photomask corresponding to each sectional shape of the micro fluidic device 1 to be fabricated, and the photoresist is developed to form a resist pattern in which positive-negative inversion of each sectional shape has taken place. Subsequently, the metallic substrate 101 having this resist pattern is dipped in a plating bath, thereby growing nickel plating on the surface of the metallic substrate 101 which is not covered by the photoresist.

Subsequently, by removing each resist pattern of the metallic substrate 101, a plural number (M) of thin film patterns 102₁, 102₂, . . . 102_{M} (hereinafter also referred to as “thin film pattern 102”) are formed on the metallic substrate 101 corresponding to the respective sectional shapes of the rectification unit 20. Patterns for plural rectifier plates 40 (see FIGS. 4A and 4B) are formed on each thin film pattern. The plural thin film patterns are laminated to compose the plural rectification parts 4.

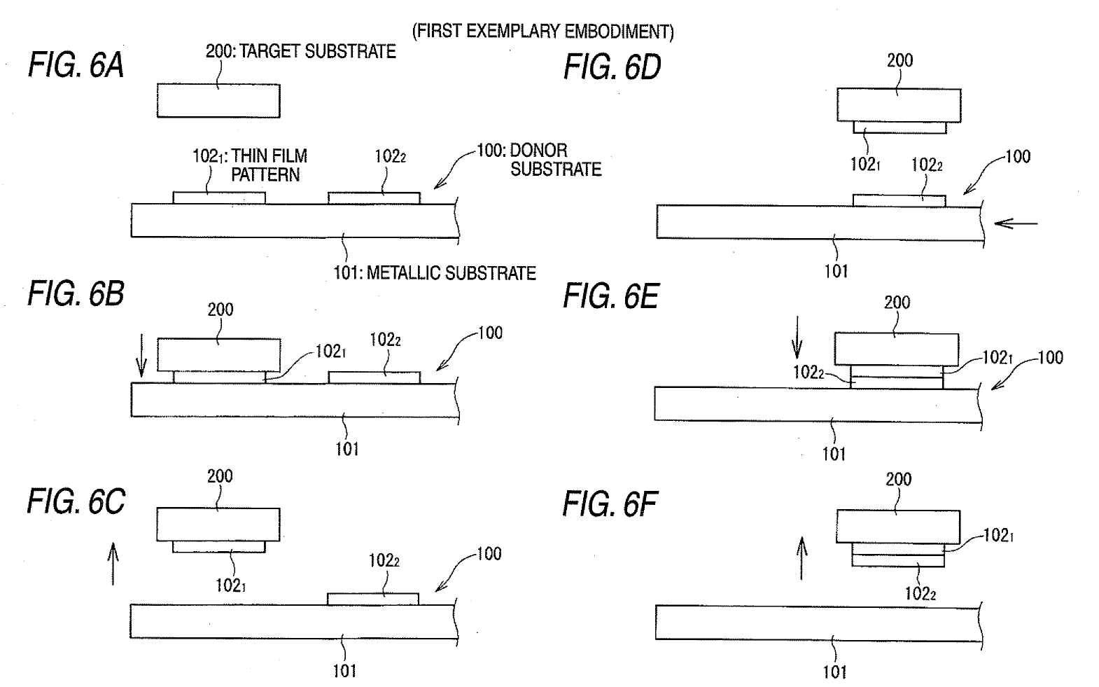

Each thin film pattern 102 on the metallic substrate 101 forms plural patterns each of which is a portion corresponding to the rectifier plate 40. The thin film pattern 102 is laminated by procedures shown in FIGS. 6A to 6F as described below, thereby fabricating the rectification unit 20.

### (Manufacturing Method of Rectification Part)

FIGS. 6A to 6F are each a view showing manufacturing steps of the rectification unit 20. Here, the lamination of the thin film patterns is carried out by means of room temperature bonding. The “room temperature bonding” as referred to herein means direct bonding of atoms to each other at room temperature. First of all, as shown in FIG. 6A, a donor substrate (first substrate) 100 is disposed on a non-illustrated lower stage within a vacuum tank, and a target substrate (second substrate) 200 is disposed on a non-illustrated upper stage within the vacuum tank. Subsequently, the inside of the vacuum tank is evacuated to a high vacuum state or a super-high vacuum state. Subsequently, the lower stage is relatively moved against the upper stage, thereby locating the thin film pattern 102₁ of the donor substrate 100 just under the target substrate 200. Subsequently, the surface of the target substrate 200 and the surface of the thin film pattern 102₁ of the donor substrate 100 are cleaned upon irradiation with an argon atom beam.

Subsequently, as shown in FIG. 6B, the target substrate 200 is descended by the upper stage, and the target substrate 200 is pressed against the donor substrate 100 under a previously determined load force (for example, 10 kgf/cm²) for a previously determined period of time (for example, 5 minutes), thereby subjecting the target substrate 200 and the thin film pattern 102₁ to room temperature bonding to each other.

Subsequently, as shown in FIG. 6C, when the target substrate 200 is ascended by the upper stage, the thin film pattern 102₁ is separated from the metallic substrate 101, whereby the thin film pattern 102₁ is transferred onto the side of the target substrate 200. This is because a bonding force between the thin film pattern 102₁ and the target substrate 200 is larger than a bonding force between the thin film pattern 102₁ and the metallic plate 101.

Subsequently, as shown in FIG. 6D, the donor substrate 100 is moved toward an arrow direction by the lower stage, thereby locating the second layer thin film pattern 102₂ on the donor substrate 100 just under the target substrate 200. Subsequently, the surface of the thin film pattern 102₁ having been transferred onto the side of the target substrate 200 (the surface coming into contact with the metallic substrate 101) and the surface of the second layer thin film pattern 102₂ are cleaned in the manner as described previously.

Subsequently, as shown in FIG. 6E, the target substrate 200 is descended by the upper stage, thereby bonding the thin film pattern 102₁ on the side of the target substrate 200 and the thin film pattern 102₂ to each other. Subsequently, as shown in FIG. 6F, when the target substrate 200 is ascended by the upper stage, the thin film pattern 102₂ is separated from the metallic substrate 101 and transferred onto the side of the target substrate 200. Thereafter, all of the thin film patterns 102₃ to 102_{M} are transferred onto the target substrate 200 from the donor substrate 100 in the same manner.

By successively repeating registration between the donor substrate 100 and the target substrate 200, bonding and isolation in the foregoing manner, the plural thin film patterns 102 corresponding to the respective sectional shapes of the rectification unit 20 are transferred onto the target substrate 200. The target substrate 200 is removed from the upper stage, and the transferred laminate on the target substrate 200 is separated from the target substrate 200, whereby the rectification parts 4a to 4p are collectively fabricated.

The rectification parts 4a to 4p may also be fabricated by a semi-conductor process. For example, a substrate made of an Si wafer is prepared; a mold releasing layer made of a polyimide is formed on this substrate by a spin coating method; an Al thin film serving as a material of the rectifier plate is formed on the surface of this mold releasing layer by a sputtering method; and the Al thin film is subjected to sputtering by a photolithography method, thereby fabricating the donor substrate.

### (Flow of Fluid in Rectification Part)

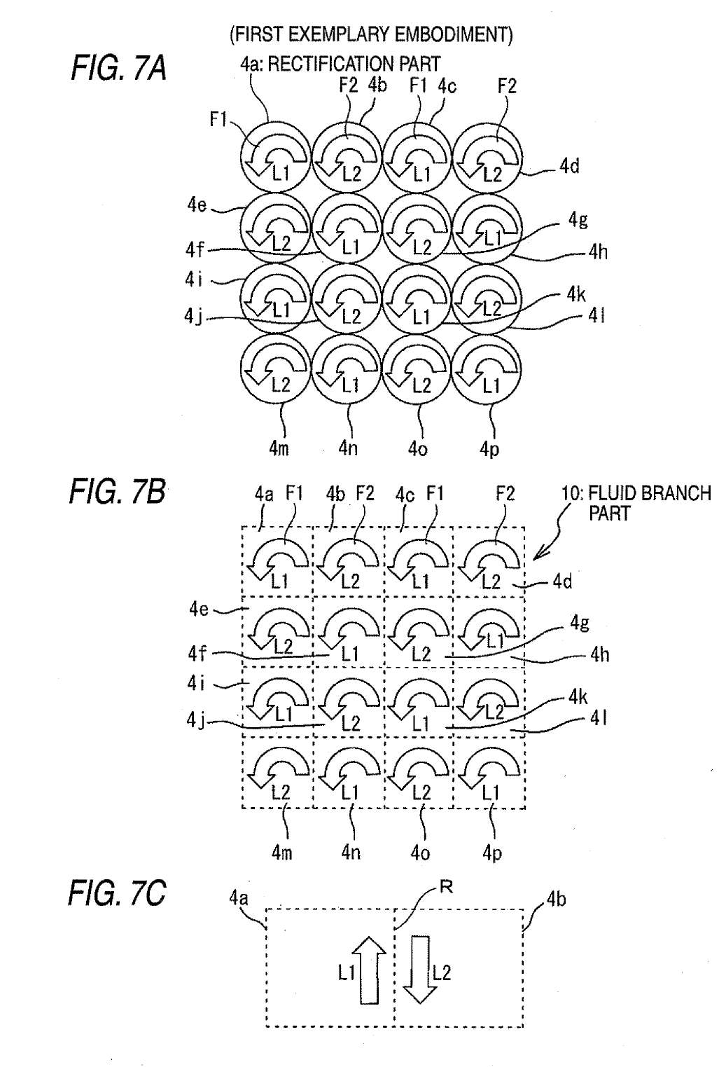

FIGS. 7A, 7B and 7C are each a view showing flows of the first fluid and the second fluid in the liquid branch part of the micro fluid device. The first fluid L1 is introduced into the first introduction pipe 2 of each of the rectification parts 4a, 4c, 4f, 4h, 4i, 4k, 4n and 4p; and the second fluid L2 is introduced into the second introduction pipe 3 of each of the rectification parts 4b, 4d, 4e, 4g, 4j, 41, 4m and 4o. Here, in case of the present exemplary embodiment, the first fluid L1 and the second fluid L2 include a fine particle (for example, a toner).

In passing through the rectification parts 4a to 4p, the first fluid L1 and the second fluid L2 are each rotated in a helical form by the rectifier plate 40. At outlets of the rectification parts 4a to 4p, all of a helical flow F1 of the first fluid L1 and a helical flow F2 of the second fluid L2 are generated in the same direction (here, in a counterclockwise direction) as shown in FIG. 7A.

In the first fluid L1 and the second fluid L2 immediately after coming out the rectification parts 4a to 7p, since a barrier for partitioning them from each other is not provided, the helical flow F1 and the helical flow F2 which are generated corresponding to each of the rectification parts 4a to 4p are in a state of coming into contact with each other as shown in FIG. 7B. For example, as shown in FIG. 7C, the helical flow F1 which has come out the rectification part 4a and the helical flow F2 which has come out the rectification part 4b flow in a reverse direction to each other at an interface R of the both. Accordingly, a shear force is generated between the first fluid L1 and the second fluid L2 at the interface R, and when a shear force is applied to the first fluid L1 and the second fluid L2 and also to fine particles included therein, it becomes easy to control the size and distribution of fine particles which are discharged from the outlet 110.

Thereafter, the first fluid L1 and the second fluid L2 advance within the common channel 11 and mix, and the mixture L3 is then discharged from the outlet 110.

In the foregoing exemplary embodiment, though only the rectification part is formed by laminating the thin film pattern, the rectification part and a portion of the main body part in the surroundings thereof may be formed by laminating the thin film pattern.

### Second Exemplary Embodiment

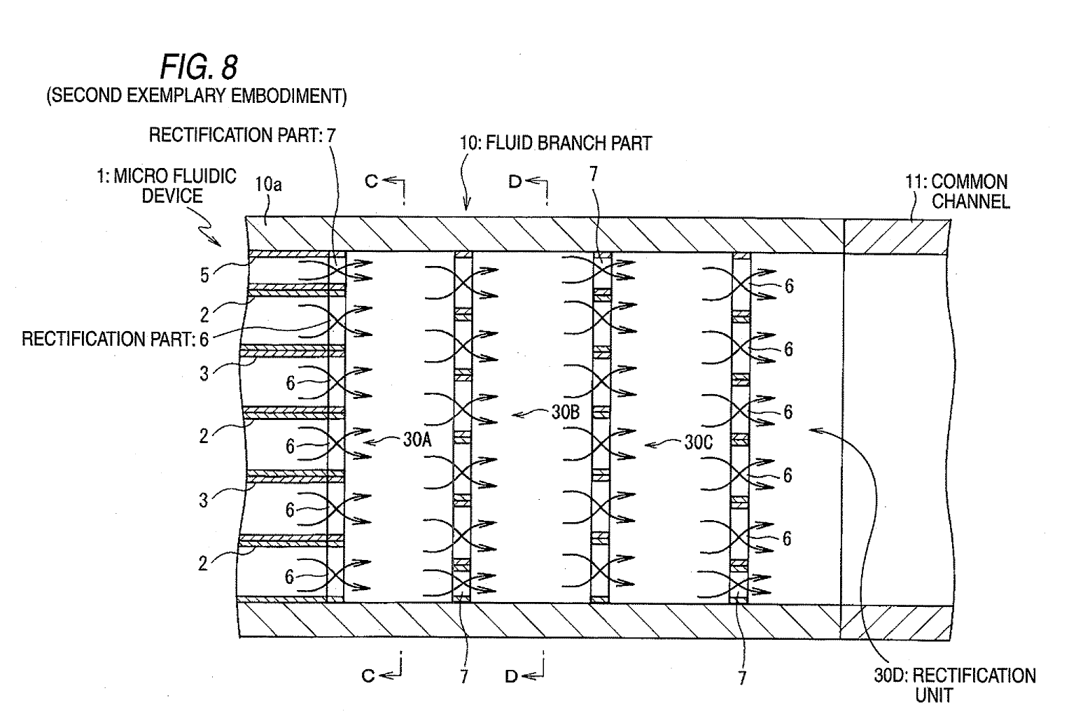

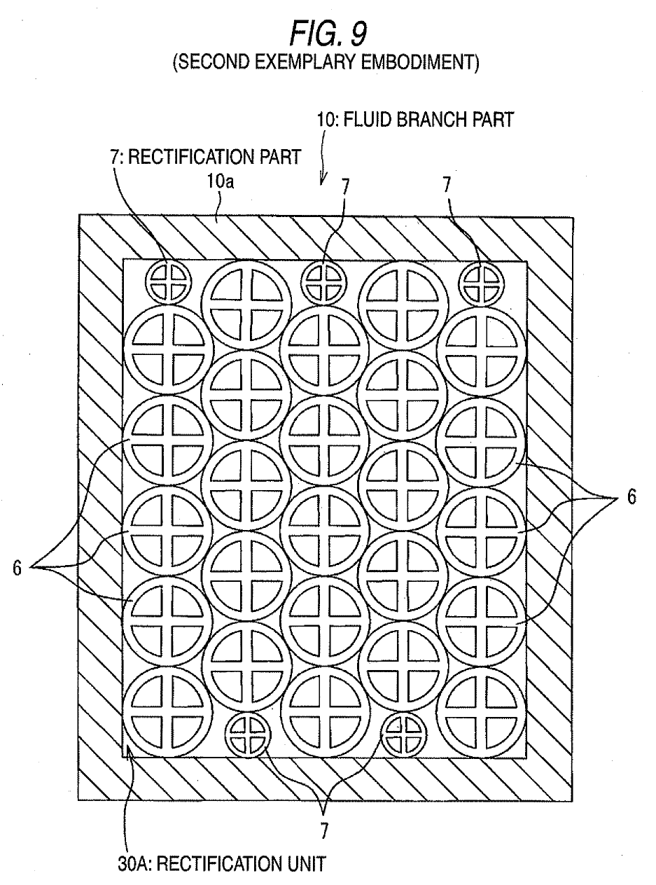

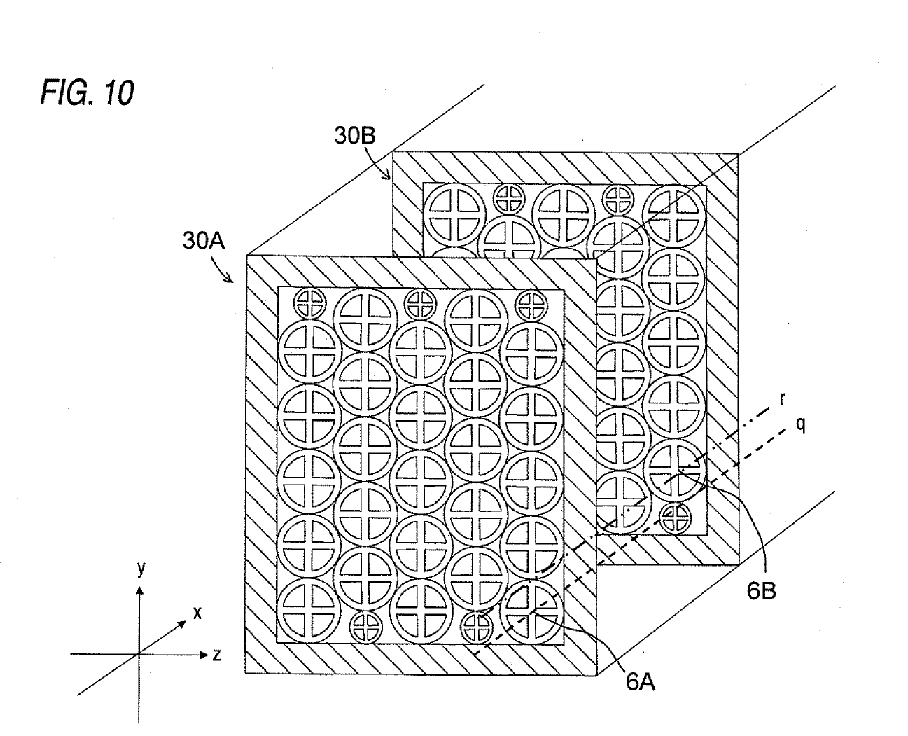

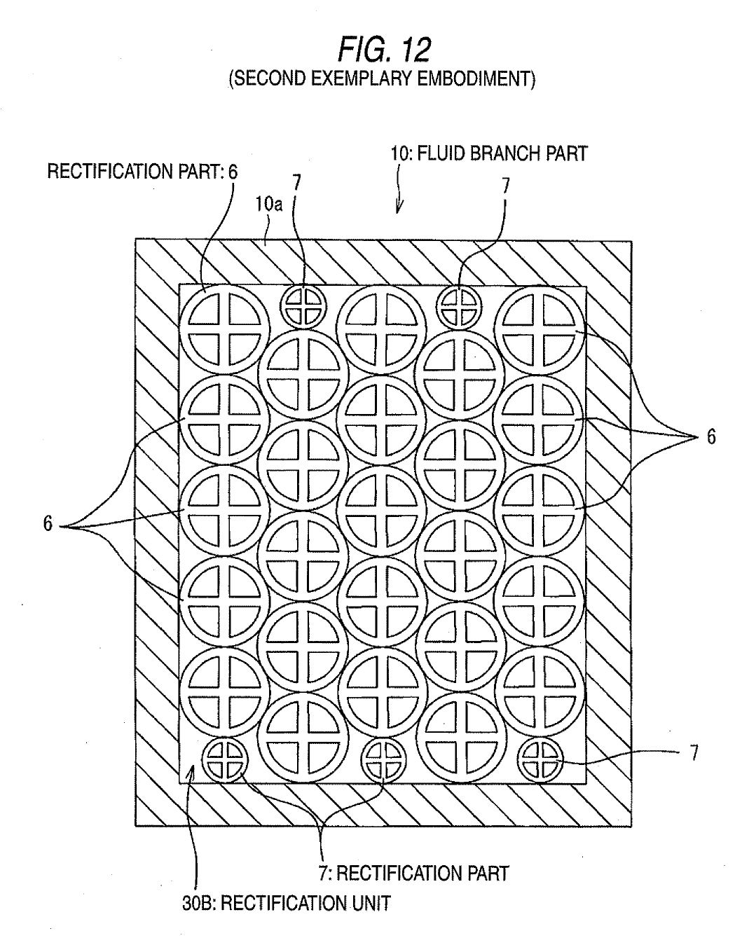

FIG. 8 is a sectional view showing a micro fluidic device according to a second exemplary embodiment of the invention; FIG. 9 is a sectional view along a C-C line in FIG. 8 as seen form a common channel (outlet) side of FIG. 8; and FIG. 12 is a sectional view along a D-D line in FIG. 8 as seen form a common channel (outlet) side of FIG. 8. In FIGS. 9 and 10, illustration of the rectifier plate 40 in each of rectification parts 6 and 7 is omitted.

In the present exemplary embodiment, rectification units 30A, 30B, 30C and 30D are arranged at fixed intervals in the flow direction of a fluid in place of the rectification unit 20 in the first exemplary embodiment shown in FIG. 2. The number of the rectification units 30A to 30D is to this four, but the number may be arbitrarily chosen.

The rectification units 30A and 30C each has a configuration shown in FIG. 9, and the rectification units 30B and 30D each has a configuration shown in FIG. 12. Each of the rectification units 30A to 30D is composed of five rows of rectification parts, and a single row is composed of five rectification parts 6 and one rectification part 7. The rectification unit 30A is provided with plural rectification parts 6 having the same structure and outer diameter of the rectifier plates 40 as in the rectification parts 4a to 4p and plural rectification parts 7 in which the structure of the rectifier plates 40 is the same, and the outer diameter thereof is substantially ½ of the rectification part 6.

As shown in FIG. 9, in the rectification units 30A and 30C, the rectification part 7 is disposed on the uppermost end of the five rectification parts 6 in a first row (row of the left-sided end); and the rectification part 7 is disposed on the lowermost end of the five rectification parts 6 in a second row (second row from the left side). Furthermore, a third row (center) and a fifth row (row of the right-sided end) have the same arrangement as the first row; and a fourth row has the same arrangement as the second row. By taking such a configuration, the adjacent rectification parts 6 are disposed in a close contact state with each other. The first introduction pipe 2 and the second introduction pipe 3 are connected to each of the rectification parts 6 of the rectification unit 30A, and a third introduction pipe 5 is connected to the rectification part 7.

FIG. 10 is a view showing rectification units disposed along a common channel. The rectification units 30A and 30B are disposed along the common channel in the direction of x shown in FIG. 10 (in an axis direction of the common channel) at a predetermined distance. In FIG. 10, rectification unit 30A is disposed as a former rectification unit and the rectification unit 30B is disposed as a latter rectification unit. The rectification parts 6 and 7 each of which belongs to the rectification unit 30A or 30B are arranged along a plane parallel to y-z plane shown in FIG. 10. The rectification parts 6 and 7 belonging to the rectification unit 30A (for example, 6A shown in FIG. 10) have center lines q (illustrated by dashed line in FIG. 10) which are parallel to x direction. In the same manner, the rectification parts 6 and 7 belonging to the rectification unit 30B (for example, 6B shown in FIG. 10) have center lines r (illustrated by dashed-two dotted line in FIG. 10) which are parallel to x direction. The center lines q and r described here are lines each passing through the center of the ring part 42 (See FIG. 4A) of the rectification part 6 or 7.

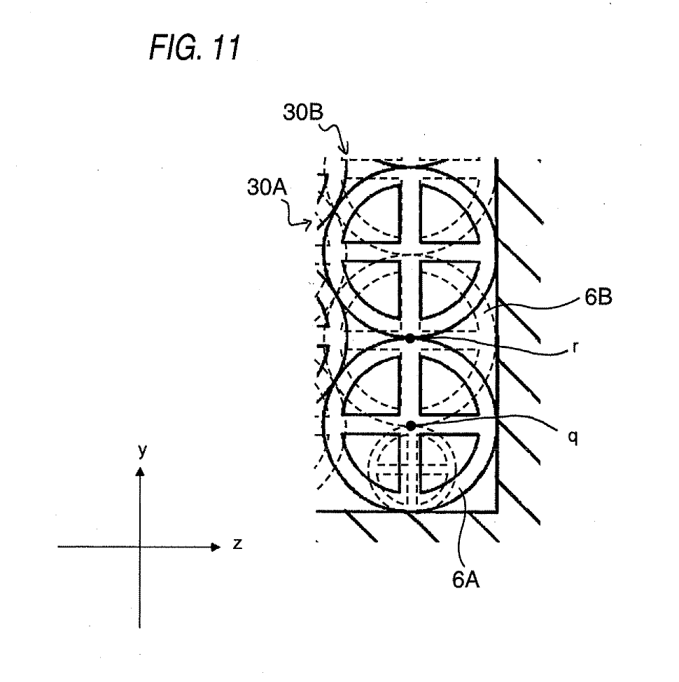

FIG. 11 is a view showing a part of the rectification units 30A and 30B of FIG. 10 toward x-direction of FIG. 10. In FIG. 11, the rectification part 6B of the latter rectification unit 30B is illustrated by dotted lines. Dots r and q shown in FIG. 11 correspond to the center lines r and q in FIG. 10, respectively.

The positions of the center lines q of the rectification parts 6 and 7 belonging to the rectification unit 30A are out of alignment with the center lines r of the rectification parts 6 and 7 belonging to the rectification unit 30B. In other wards, the center lines q do not overlap with the center lines r.

The above explanation is not limited to the arrangements of the rectification parts of the rectification units 30A and 30B, but is also applied to arrangements of rectification parts of another former rectification unit and another latter rectification unit (for example the arrangements of the rectification parts of the rectification unit 30B and the rectification unit 30C, or the like).

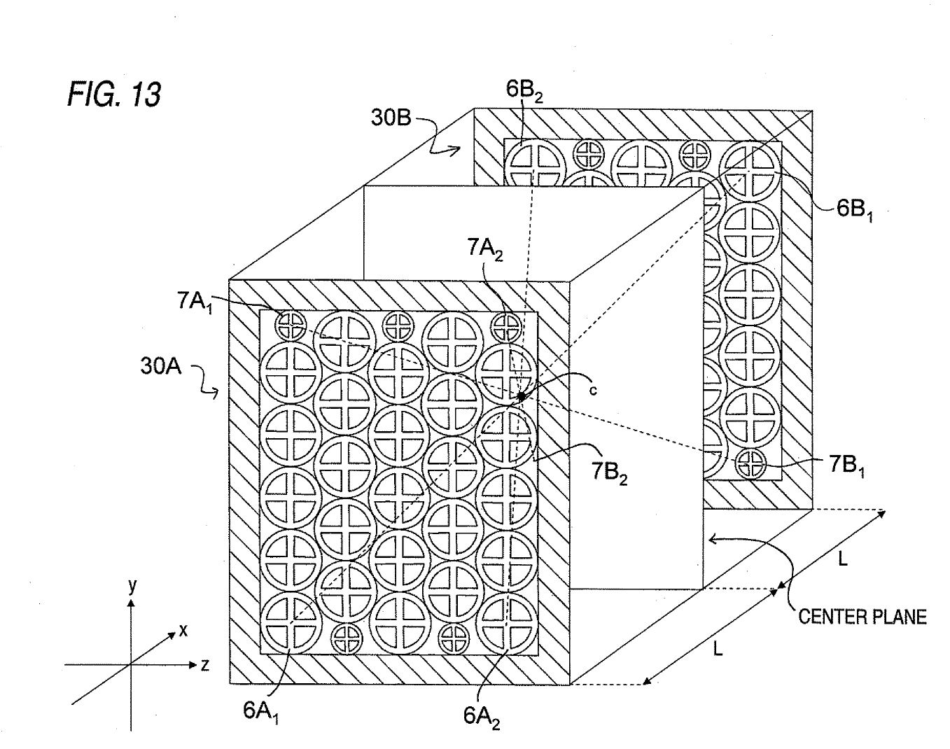

Also, as shown in FIG. 12, in the latter rectification unit (30B and 30D, for example), the rectification parts 6 and 7 are located upside down with respect to the rectification parts 6 and 7 disposed in each of the rows of the former rectification unit 30A. FIG. 13 is a view showing a positional relationship between rectification parts of the rectification unit 30A and rectification parts of the rectification unit 30B shown in FIG. 10. In FIG. 13, a center plane is disposed between the rectification unit 30A and the rectification unit 30B, for purpose of illustration. A distance between the center plane and the rectification unit 30A and a distance between the center plane and the rectification unit 30B are equidistance L. The center plane intersects a center line of the common channel in the axis direction at a point c. As illustrated with dashed line in FIG. 13, the rectification parts 6B₁, 6B₂, 7B₁ and 7B₂ (the rectification part 7B₂ is invisible in FIG. 13) of the latter rectification unit 30B and the rectification parts 6A₁, 6A₂, 7A₁ and 7A₂ of the former rectification unit 30A are symmetry with respect to the point c.

The above explanation is not limited to the arrangements of the rectification parts of the rectification units 30A and 30B, but is also applied to arrangements of rectification parts of another former rectification unit and another latter rectification unit (for example the arrangements of the rectification parts of the rectification unit 30B and the rectification unit 30C, or the like).

Since the action of the present exemplary embodiment is the same as in the first exemplary embodiment, its explanation is omitted.

### Other Exemplary Embodiments

The invention is not limited to the foregoing respective exemplary embodiments, and various modifications may be made within the range where the gist of the invention is not changed. For example, a combination of constitutional elements among the respective exemplary embodiments may be arbitrarily made.

Also, in the foregoing respective exemplary embodiments, while the configuration where two fluids are mixed has been shown, the two fluids may be the same fluid, or may be a different fluid from each other. Also, there may be adopted a configuration where two or more fluids which are the same or different are mixed.

Also, the main body part of the fluid branch part or the common channel may be formed by laminating a thin film pattern.

### Third Exemplary Embodiment

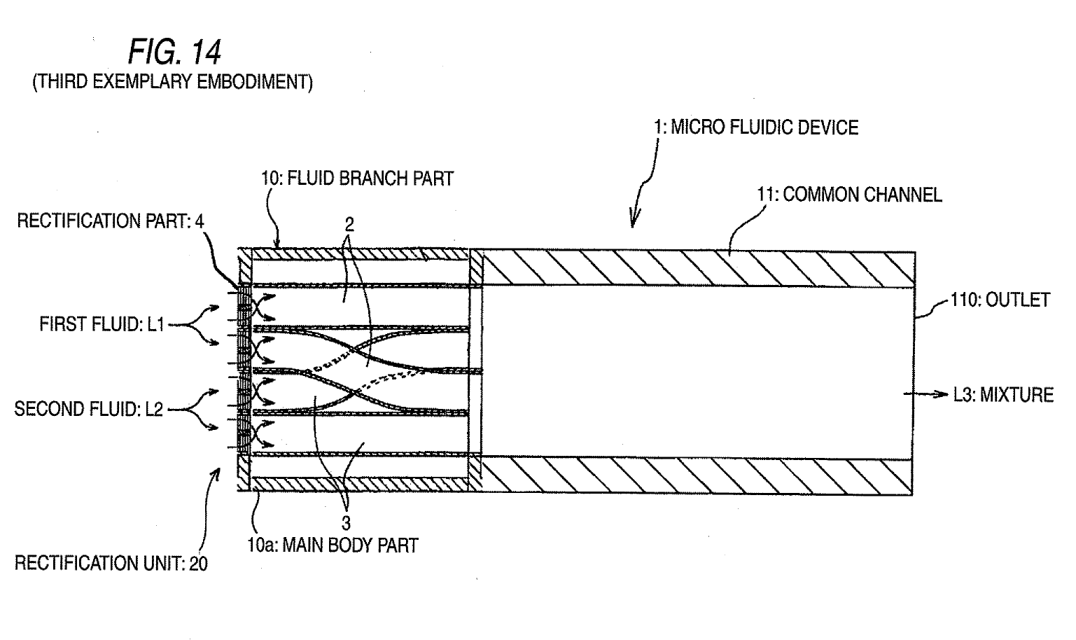

FIG. 14 is an example of side view showing a micro fluidic device according to a third exemplary embodiment of the invention.

In the foregoing respective exemplary embodiments, while the configuration where a flow is branched in a fluid branch part such that two fluids flow adjacent to each other, and a helical flow is then generated in each of the fluids in a rectification part has been shown, there may be adopted a configuration where a helical flow is generated in advance in each fluid in a rectification part, the flow is then branched in a fluid branch part such that two fluids flow adjacent to each other, and the two fluids are mixed in a merging channel, as shown in FIG. 14.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A micro fluidic device comprising:
at least one first introduction pipe into which first fluid is introduced;
at least one second introduction pipe into which second fluid is introduced, the second introduction pipe being disposed adjacent to the first introduction pipe;
a common channel connected to the first introduction pipe and the second introduction pipe, wherein in the common channel the first fluid and the second fluid are mixed; and
a first group of rectification parts, the rectification parts of the first group being provided individually for the first introduction pipe or the second introduction pipe and generating a helical flow in the first fluid and the second fluid,
wherein the helical flow in the first fluid and the helical flow in the second fluid have a same circumferential direction.

2. The micro fluidic device according to claim 1,
wherein the first group is formed of a plurality of rectification parts each having a plurality of rectifier plates,
the plurality of rectifier plates are stacked,
the plurality of rectifier plates constitute the respective rectification parts, and
each of the plurality of rectifier plates is shifted by a certain angle other than 0 degree with respect to a corresponding rectifier plate of another rectifier plate adjacent to the one rectifier plate.

3. The micro fluidic device according to claim 1, further comprising: a second group of rectification parts including first rectification parts and second rectification parts, the first rectification parts being adjacent to the rectification parts of the first group and the second rectification parts being adjacent to the first rectification parts,
wherein the first rectification parts are placed at prescribed interval from the rectification parts of the first group in an axis direction of the common channel,
the first rectification parts are placed at prescribed interval from the second rectification parts in the axis direction, and
centerlines of the first rectification parts in the axis direction do not overlap with centerlines of the second rectification parts in the axis direction and centerlines of the rectification parts of the first group in the axis direction.

4. The micro fluidic device according to claim 1,
wherein the first group is formed of a plurality of rectification parts each having a plurality of rectifier plates,
the plurality of rectifier plates are stacked,
the plurality of rectifier plates constitute the respective rectification parts, and
each of the plurality of rectifier plates has a cross-shaped part and a ring part.

5. The micro fluidic device according to claim 3,
wherein a certain plane is located between the first rectification parts and the second rectification parts,
a distance between the certain plane and the first rectification parts is equal to that between the certain plane and the second rectification parts, and
positions of the first rectification parts and positions of the second rectification parts are symmetry with respect to a point at which the certain plane intersects a center line of the common channel.

6. The micro fluidic device according to claim 1,
wherein rectification parts of the first group are located upstream of the first introduction pipe and the second introduction pipe in a flowing direction of the first fluid and the second fluid.

7. The micro fluidic device according to claim 1,
wherein rectification parts of the first group are located downstream of the first introduction pipe and the second introduction pipe in a flowing direction of the first fluid and the second fluid.

8. A fluid control method comprising:
flowing a first fluid and a second fluid individually so that the first fluid and the second fluid rotate helically in a same circumferential direction; and
controlling the helically rotated first fluid and second fluid so that rotation directions of the first fluid and second fluid at an interface therebetween are opposite to each other.
